(19) United States
(12) Patent Application Publication
(10) Pub. No.: US 2025/0168276 A1
(43) Pub. Date: May 22, 2025

(54) HANDLING ASSISTANCE SYSTEM, HANDLING ASSISTANCE METHOD, AND PROGRAM

(71) Applicant: NTT TechnoCross Corporation, Tokyo (JP)

(72) Inventors: Takashi AOKI, Tokyo (JP); Hosana KAMIYAMA, Tokyo (JP); Kazuhira MATSUI, Tokyo (JP)

(73) Assignee: NTT TechnoCross Corporation, Tokyo (JP)

(21) Appl. No.: 18/839,418

(22) PCT Filed: Feb. 21, 2022
(86) PCT No.: PCT/JP2022/006952

§ 371 Date: Aug. 17, 2024

(51) Int. Cl. H04M 3/42; G10L 15/22; G10L 15/26; G10L 15/30

(52) U.S. Cl. CPC H04M 3/42221; G10L 15/22; G10L 15/26; G10L 15/30

(57) ABSTRACT

A handling assistance system according to an embodiment is a handling assistance system communicably connected to a first terminal used by a first user who is in charge of call handling of a customer and a second terminal used by a second user who assists with the call handling, and includes a speech recognition unit configured to perform speech recognition on voice data in the call handling, to generate a speech recognition text indicating a result of the speech recognition, a summary unit configured to generate a summary text, which is a summary of the speech recognition text, in response to receiving an assistance request regarding the call handling from the first terminal, and an notifying unit configured to cause an assistance requesting notification to be displayed on the second terminal together with a predetermined notification sound, the assistance requesting notification including the summary text.

### TECHNICAL FIELD

The present invention relates to a handling assistance system, a handling assistance method, and a program.

### BACKGROUND ART

A system for assisting operators, who belong to a contact center (or also referred to as a call center), with handling of customers has been known (NPL 1). Such a system is referred to as, for example, a handling assistance system (or an operator assistance system), and, in general, has various functions such as a function for transcribing what is talked about on a call into a text, a function for requesting assistance of a supervisor, and the like. The supervisor is a person who monitors a talk on a call of an operator, and assists the operator with handling when a problem is likely to occur or in response to an assistance request from the operator.

### CITATION LIST

### Non-Patent Literature

[NPL 1] ForeSight Voice Mining, Internet <URL:https://www.ntt-tx.co.jp/products/foresight_vm/>

### SUMMARY OF THE INVENTION

### Technical Problem

However, according to existing handling assistance systems, the supervisor may not be able to respond to an assistance request quickly when an operator requests assistance. The supervisor needs to hear the reason why the operator is requesting assistance, but the operator may be poor at objectively and briefly communicating the reason why he/she is requesting assistance. Moreover, the supervisor is often doing various jobs other than monitoring the operators' calls, so may not be aware of an assistance request from an operator. Particularly, in recent years, both operators and supervisors may be working from home, and this is considered to increase the chances a supervisor may remain unaware of an assistance request from an operator.

An embodiment of the present invention is made in view of the respect described above, and an object thereof is to realize a quick response to an assistance request.

### Solution to the Problem

To achieve the object described above, a handling assistance system according to an embodiment is a handling assistance system communicably connected to a first terminal used by a first user who is in charge of call handling of a customer and a second terminal used by a second user who assists with the call handling, and includes a speech recognition unit configured to perform speech recognition on voice data in the call handling, to generate a speech recognition text indicating a result of the speech recognition, a summary unit configured to generate a summary text, which is a summary of the speech recognition text, in response to receiving an assistance request regarding the call handling from the first terminal, and an notifying unit configured to cause an assistance requesting notification to be displayed on the second terminal together with a predetermined notification sound, the assistance requesting notification including the summary text.

### Advantageous Effects of the Invention

It is possible to realize a quick response to an assistance request.

### BRIEF DESCRIPTION OF THE DRAWINGS

FIG. 1 is a diagram illustrating an example of the entire configuration of a contact center system according to an embodiment.

FIG. 2 is a diagram illustrating an example of a functional configuration of a handling assistance system, an operator terminal, and a supervisor terminal according to an embodiment.

FIG. 3 is a sequence diagram illustrating an example of an operation in a case of requesting assistance.

FIG. 4 is a drawing (part 1) illustrating an example of an operator monitor window and an assistance requesting notification.

FIG. 5 is a drawing (part 2) illustrating an example of an operator monitor window and an assistance requesting notification.

FIG. 6 is a sequence diagram illustrating an example of an operation in a case of selecting “see details” on an assistance requesting notification.

FIG. 7 is a diagram (part 1) illustrating an example of a call details window.

FIG. 8 is a diagram (part 2) illustrating an example of a call details window.

FIG. 9 is a sequence diagram illustrating an example of an operation in a case of selecting “ask another SV” on an assistance requesting notification.

FIG. 10 is a diagram illustrating an example of an operator monitor window and an assistance requesting notification in a case where an assistance request is forwarded from another supervisor.

### DESCRIPTION OF EMBODIMENTS

An embodiment of the present invention will be described below. In the present embodiment, a contact center system 1 that, targeting a contact center, enables a supervisor's quick response to an operator's assistance request will be described. The contact center is an example. Targeting a person in charge of something, who works in an office or the like other than a contact center, the present embodiment is also applicable to a case where a superordinate or the like responds to an assistance request from the person in charge. More generally, the present embodiment is also applicable to a case where, for example, a person in charge of a certain type of work requests assistance of another person, who then responds to the assistance request.

### Entire Configuration of Contact Center System 1

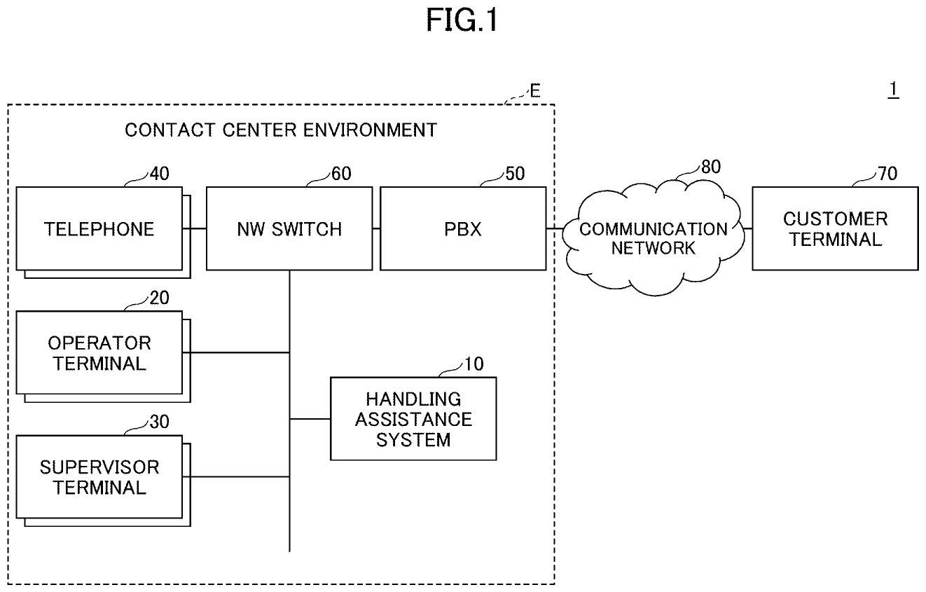

An example of the entire configuration of the contact center system 1 according to the present embodiment is illustrated in FIG. 1. As illustrated in FIG. 1, the contact center system 1 according to the present embodiment includes a handling assistance system 10, one or more operator terminals 20, one or more supervisor terminals 30, one or more telephones 40, a Private Branch exchange (PBX) 50, a NW switch 60, and a customer terminal 70. Here, the handling assistance system 10, the operator terminals 20, the supervisor terminals 30, the telephones 40, the PBX 50, and the NW switch 60 are included in a contact center environment E, which is a system environment of the contact center. The contact center environment E is not limited to a system environment within one building, and may be, for example, a system environment in a plurality of geographically separated buildings. Particularly, the contact center environment E may include system environments used by operators and supervisors who work in such work styles as work from home, remote work, and the like (e.g., operators' and supervisors' homes' system environments, and the like).

The handling assistance system 10 is a server, a group of servers, and the like possessing various functions for assisting operators' call handling. When an assistance requesting function, which is one of its functions, is used, the handling assistance system 10 notifies a supervisor of information necessary for understanding the reason why an operator is requesting assistance, in a manner in which the supervisor can be easily aware of the operator's assistance request. Hence, the supervisor can quickly start dealing with the operator's assistance request.

The handling assistance system 10 has various functions. In the present embodiment, it is assumed that the handling assistance system 10 has at least the following functions (1) to (6).
(1) a speech recognition function: a function for transcribing the content of a talk on a call between an operator and a customer into a text using packets (voice packets) sent from the NW switch 60
(2) a call text providing function: a function for providing the entirety or a part of the content of a talk on a call transcribed into a text by the speech recognition function (hereinafter, may also be referred to as a call text) to an operator terminal 20 or a supervisor terminal 30
(3) a search function: a function for searching call data including various information regarding calls between operators and customers, and providing the search result to an operator terminal 20 or a supervisor terminal 30
(4) a summary function: a function for generating a summary text, which is a summary of a call text
(5) a call monitor function: a function for providing a supervisor terminal 30 with information for monitoring an operator's call (e.g., a call text of the call, or a NG word included in the call text)
(6) an assistance requesting function: a function for an operator to request assistance of a supervisor regarding handling

The handling assistance system 10 may have various functions in addition to the functions (1) to (6) described above. For example, the handling assistance system 10 may have various functions such as a function for identifying a call reason (a reason why a received call is made) from a call text and the like, a function for identifying whether a call is inbound or outbound, a function for identifying the reason why assistance is requested based on a call text, a function for providing a chat between an operator terminal 20 and a supervisor terminal 30, a function for providing various analyses to call data, and the like. In addition to these functions, the handling assistance system 10 may have, for example, the various functions described in NPL 1.

The operator terminal 20 is any of various types of terminals such as a personal computer (PC) and the like that is used by an operator. In a case where an operator works in a work style such as work from home, remote work, and the like, the operator terminal 20 may be installed in the operator's home and the like. Alternatively, the operator terminal 20 may be installed in the call center, and the operator may use the operator terminal 20 from another terminal via an application such as a remote desktop and the like.

The supervisor terminal 30 is any of various types of terminals such as a PC and the like that is used by a supervisor. A supervisor (SV) is a person who monitors a talk on a call of an operator, and assists the operator with handling when a problem is likely to occur or in response to an assistance request from the operator. A size of a group of operators is typically from a few operators to a few tens of operators, and one supervisor monitors calls of the group. In a case where the supervisor works in a work style such as work from home, remote work, and the like, the supervisor terminal 30 may be installed in the supervisor's home and the like. Alternatively, the supervisor terminal 30 may be installed in the call center, and the supervisor may use the supervisor terminal 30 from another terminal via an application such as a remote desktop and the like.

The operator terminal 20 and the supervisor terminal 30 are not limited to a PC, and may be, for example, a smartphone, a tablet terminal, a wearable device, and the like.

The telephone 40 is an Internet Protocol (IP) telephone (a fixed IP telephone, a portable IP telephone, and the like) used by an operator. Typically, one operator terminal 20 and one telephone 40 are, for example, installed on an operator's desk.

The PBX 50 is a private branch exchange (IP-PBX), and is connected to a communication network 80 including a Voice over Internet Protocol (VOIP) network and a Public Switched Telephone Network (PSTN).

The NW switch 60 is configured to relay packets (voice packets) between the telephone 40 and the PBX 50, and to capture the packets and send them to the handling assistance system 10.

The customer terminal 70 is any of various types of terminals such as a smartphone, a portable phone, a fixed telephone, and the like that is used by a customer.

The entire configuration of the contact center system 1 illustrated in FIG. 1 is an example, and the contact center system 1 may have any other configuration. For example, in the example illustrated in FIG. 1, the PBX 50 is an on-premise-type private branch exchange. However, the PBX 50 may be a private branch exchange realized by a cloud service. Moreover, for example, in a case where the handling assistance system 10 is realized by one server, it may be referred to as a handling assistance device or the like. Moreover, in a case where the operator terminal 20 also functions as an IP telephone, the operator terminal 20 and the telephone 40 may be combined.

### Functional Configuration of Handling Assistance System 10, Operator Terminal 20, and Supervisor Terminal 30

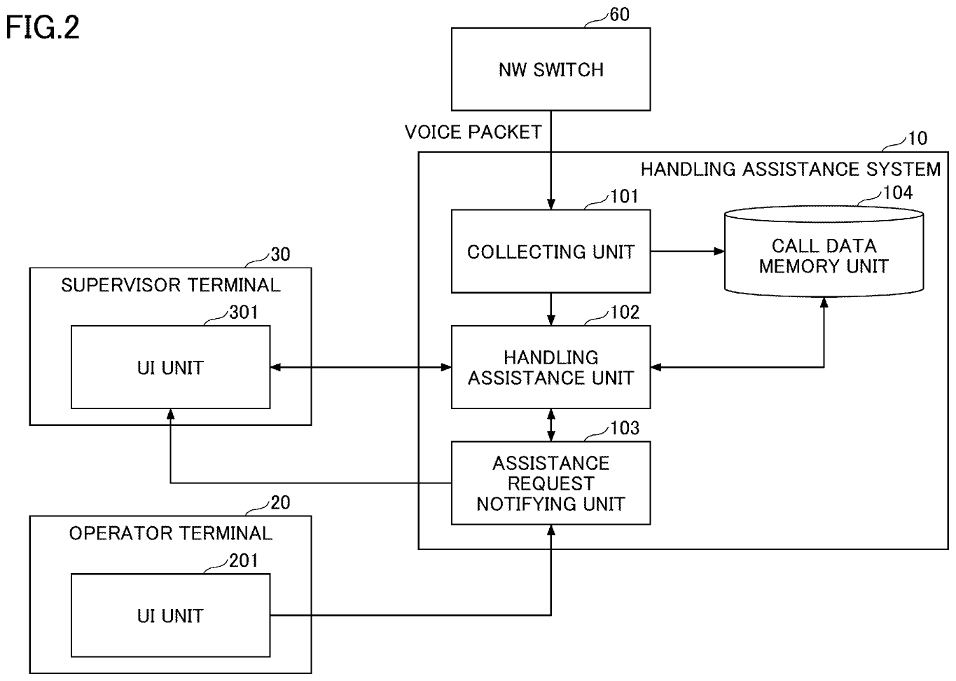

An example of the functional configuration of the handling assistance system 10, the operator terminal 20, and the supervisor terminal 30 according to the present embodiment is illustrated in FIG. 2.

### Handling Assistance System 10

As illustrated in FIG. 2, the handling assistance system 10 according to the present embodiment includes a collecting unit 101, a handling assistance unit 102, and an assistance request notifying unit 103. For example, these units are realized by processes that one or more programs installed in the handling assistance system 10 cause a processor such as a Central Processing Unit (CPU) or the like to execute. The handling assistance system 10 according to the present embodiment also includes a call data memory unit 104. The call data memory unit 104 is realized by an auxiliary memory device such as a Hard Disk Drive (HDD), a Solid State Drive (SSD), and the like. The call data memory unit 104 may be realized by, for example, a memory device or the like connected to the handling assistance system 10 through a communication network.

The collecting unit 101 is configured to receive voice packets sent from the NW switch 60, and stores voice data included in the voice packets in the call data memory unit 104 as call data in association with a call ID. The call ID is information uniquely identifying a call between an operator and a customer.

The handling assistance unit 102 is configured to realize various functions such as the speech recognition function, the call text providing function, the search function, the summary function, the call monitor function, the assistance requesting function, and the like (i.e., the functions described in (1) to (6) above). Here, the speech recognition function performs speech recognition on the voice data included in the voice packets received by the collecting unit 101, and stores a call text, which is the result of the speech recognition in the call data memory unit 104 as call data in association with the call ID. The handling assistance unit 102 may realize various functions for assisting operators' call handling, in addition to the functions (1) to (6) described above.

The assistance request notifying unit 103 is configured to notify a supervisor of information necessary for understanding the reason why assistance is requested, in a manner in which the supervisor can be easily aware of the assistance request from an operator terminal 20, when the assistance requesting function is used on the operator terminal 20.

The call data memory unit 104 is configured to store call data. Call data is data including various information regarding a call between an operator and a customer, and includes various information associated with the call ID of the call Examples of the information included in concerned. call data include a call text, which is a result of speech recognition performed on voice data of the call concerned, the voice data of the call, the operator ID and the operator name of the operator who was in charge of handling the call, the call date and time of the call and the time taken for the call, the phone number of the customer on the call, and the like. These are examples, and call data does not need to include some of these pieces of information, or may include information other than these. The operator ID is information uniquely identifying an operator.

### Operator Terminal 20

As illustrated in FIG. 2, the operator terminal 20 according to the present embodiment includes a UI unit 201. The UI unit 201 is realized by, for example, a process that one or more programs installed in the operator terminal 20 causes a processor such as a CPU or the like to execute.

The UI unit 201 is configured to display various types of User Interface (UI) windows on a display and receive operations from the operator via the UI windows. A UI window displayed by the UI unit 201 may be, for example, an operator assisting window on which a call text of an ongoing call is displayed in real time, and that includes a button or the like for requesting assistance of a supervisor.

### Supervisor Terminal 30

As illustrated in FIG. 2, the supervisor terminal 30 according to the present embodiment includes a UI unit 30. The UI unit 301 is realized by, for example, a process that one or more programs installed in the supervisor terminal 30 cause a processor such as a CPU or the like to execute.

The UI unit 301 is configured to display various types of UI windows on a display and receive operations from the supervisor via these UI windows. A UI window displayed by the UI unit 301 may be, for example, an operator monitor window via which the supervisor monitors a call of an operator whom the supervisor previously designated.

### Example of Operation

An example of an operation in a case of informing a supervisor of an operator's assistance request on an assumption that the operator of a given operator terminal 20 is talking with a customer on a call will be described below. It is assumed that voice packets of the ongoing call are being received by the collecting unit 101 and a call text is being acquired in real time from voice data included in the voice packets by the speech recognition function.

### Example of Operation in Case of Requesting Assistance

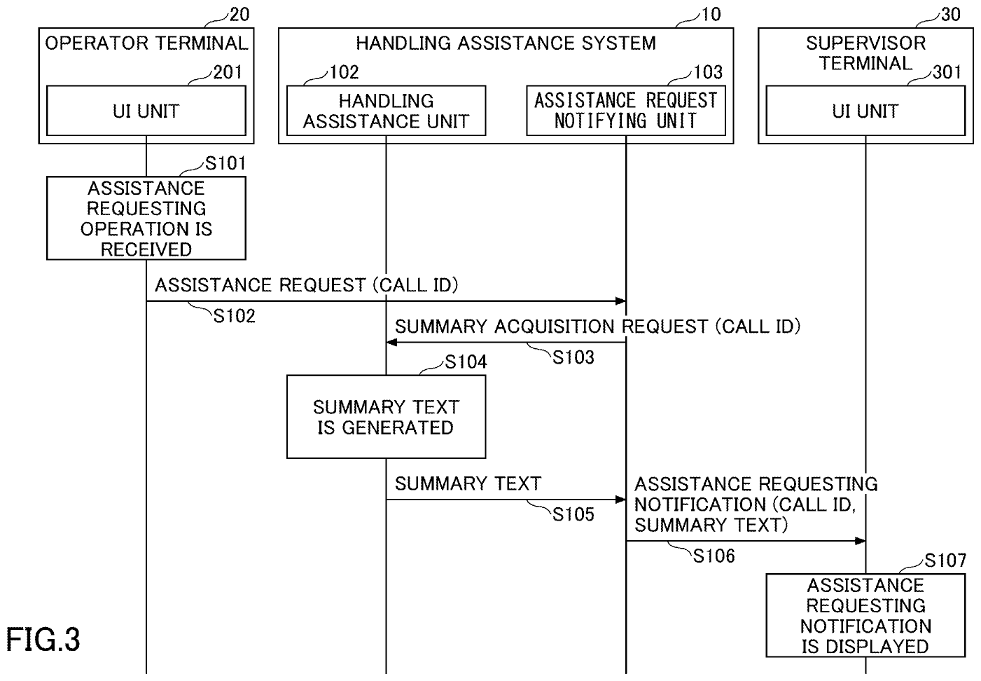

First, an example of an operation in a case of the operator requesting assistance of a supervisor will be described with reference to FIG. 3.

The UI unit 201 of the operator terminal 20 receives an assistance requesting operation from the operator (step S101). Here, for example, the operator can perform an assistance requesting operation on the operator assisting window. Moreover, here, the operator may select the reason why he/she is requesting assistance from previously defined options, or may freely input the reason why he/she is requesting assistance. For example, the operator may perform an assistance requesting operation without designating a specific supervisor, or may perform an assistance requesting operation by designating a specific supervisor. In a case where no specific supervisor is designated, the supervisor who is in charge of monitoring calls of the group to which the operator who has performed the assistance requesting operation belongs is designated.

Upon receiving the operator's assistance requesting operation, the UI unit 201 of the operator terminal 20 sends an assistance request to the handling assistance system 10 (step S102). Here, the assistance request includes the call ID of the call. The assistance request may also include the reason (assistance requesting reason) the operator selected or input in the step S101 described above, in addition to the call ID.

The assistance request notifying unit 103 of the handling assistance system 10 sends a summary acquisition request to the handling assistance unit 102 in response to receiving the assistance request from the operator terminal 20 (step S103). The summary acquisition request includes the call ID of the call.

In response to receiving the summary acquisition request, the handling assistance unit 102 of the handling assistance system 10 generates a summary text from the call data corresponding to the call ID included in the summary acquisition request (step S104). That is, the handling assistance unit 102 generates a summary text, which is a summary of the call text included in the call data corresponding to the call ID (e.g., the call text for a predetermined period of time until the assistance requesting operation is performed, or the like), by a text summarizing technique, which is one of known natural language processing techniques. Here, the handling assistance unit 102 may identify the operator name of the operator who is in charge of handling the call, may identify the current call reason of the call, or may identify whether the call is inbound or outbound. The handling assistance unit 102 may identify the reason why assistance is requested based on the call text by a question answering technique, which is one of natural language processing techniques, and in which the assistance request is the question, and the reason why assistance is requested is the answer.

The handling assistance unit 102 of the handling assistance system 10 sends the summary text generated in the step S104 described above to the assistance request notifying unit 103 (step S105). Here, the handling assistance unit 102 may also send, for example, the operator name, the call reason, whether inbound or outbound, the reason why assistance is requested, and the like in addition to the summary text.

In response to receiving the summary text and the like, the assistance request notifying unit 103 of the handling assistance system 10 sends an assistance requesting notification to the supervisor terminal 30 of the corresponding supervisor (i.e., for example, the supervisor designated by the operator, or the supervisor who is in charge of monitoring calls of the group to which the operator who has performed the assistance requesting operation belongs) (step S106). Here, the assistance requesting notification includes the call ID and the summary text. The assistance requesting notification may also include, for example, the operator name, the call reason, whether inbound or outbound, the reason why assistance is requested, and the like in addition to the call ID and the summary text. In the following description, it is assumed that the assistance requesting notification includes the call ID, the summary text, the operator name, the call reason, whether inbound or outbound, and the reason why assistance is requested.

In response to receiving the assistance requesting notification from the handling assistance system 10, the UI unit 301 of the supervisor terminal 30 displays the assistance requesting notification including information necessary for understanding the reason why assistance is requested, in a manner in which the supervisor can be easily aware of the assistance request (step S107). Specifically, the UI unit 301 displays the assistance requesting notification as a pop-up on the operator monitor window together with a predetermined sound (notification sound). The notification sound is a desirably selected sound that is previously set, and is not limited to what is generally referred to as sound effects and the like, and may be, for example, a piece of music, a melody, a sound (including a synthetic sound), and the like.

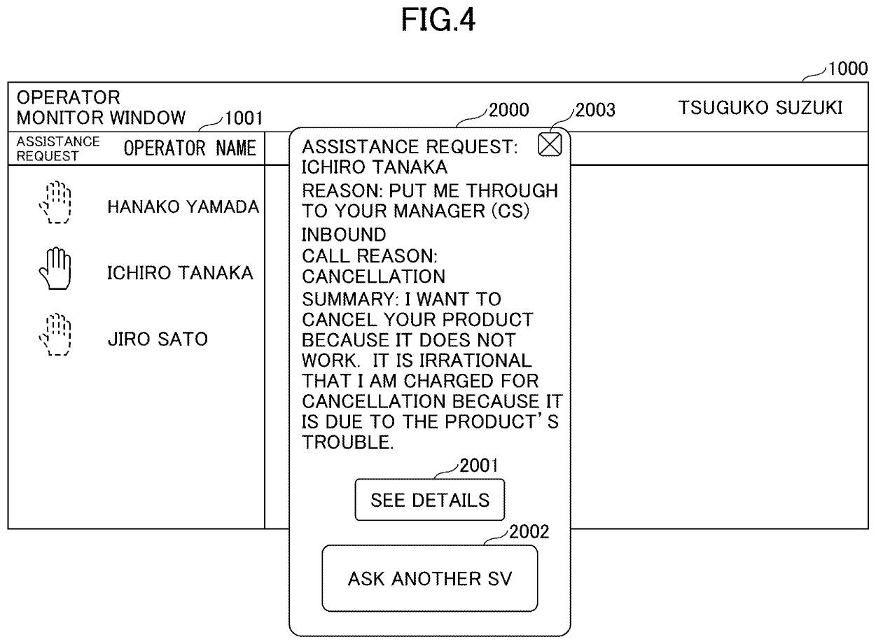

Here, an example of the operator monitor window and the assistance requesting notification displayed as a pop-up on the operator monitor window is illustrated in FIG. 4. In the example illustrated in FIG. 4, an assistance requesting notification 2000 is displayed as a pop-up on an operator monitor window 1000.

The operator monitor window 1000 illustrated in FIG. 4 is an operator monitor window displayed on the supervisor terminal 30 of a supervisor named “Tsuguko Suzuki”, and includes a monitor target operator display field 1001 in which the names of the monitor target operators, and icons representing whether the operators are requesting assistance or not (hereinafter, may also be referred to as palm icons) are displayed. In the example illustrated in FIG. 4, three operators including “Hanako Yamada”, “Ichiro Tanaka”, and “Jiro Sato” are the monitor targets, and the palm icon of the operator “Ichiro Tanaka”, who is requesting assistance, is displayed by a solid line. On the other hand, the palm icons of the operators “Hanako Yamada” and “Jiro Sato”, who are not requesting assistance, are displayed by a broken line.

The operator name, the reason why assistance is requested, whether inbound or outbound, the call reason, and the summary text that are included in the assistance requesting notification are displayed in the assistance requesting notification 2000 illustrated in FIG. 4. In the example illustrated in FIG. 4, the operator name “Ichiro Tanaka”, the reason why assistance is requested “Put me through to your manager (CS)”, “inbound”, the call reason “cancellation”, and the summary text “I want to cancel your product because it does not work. It is irrational that I am charged for cancellation because it is due to the product's trouble.” are displayed. “CS” in the reason why assistance is requested indicates a reason on the customer side. On the other hand, a reason on the operator side is indicated as “OP”.

Here, the assistance requesting notification 2000 illustrated in FIG. 4 includes a “see details” button 2001 for confirming the detailed call content on the call under the assistance request, an “ask another SV” button 2002 for entrusting (forwarding) the assistance request to another supervisor, and a “delete” button 2003 for hiding the assistance requesting notification 2000. An example of an operation in a case where the “see details” button 2001 or the “ask another SV” button 2002 is selected by the supervisor will be described below.

By the assistance requesting notification 2000 illustrated in FIG. 4 being displayed as a pop-up together with the predetermined notification sound, the supervisor can easily know that an assistance request has been made. Moreover, because the summary text of the call under the assistance request is displayed in the assistance requesting notification 2000, the supervisor can know with what he/she should assist the operator without hearing the reason why the operator is requesting assistance, and can quickly respond to the assistance request (in other words, can shorten the time taken to be able to be actually of assistance to the operator). However, the summary text of the call being displayed is an example and non-limiting, and any other information may be displayed as long as it is information based on which the supervisor can know with what he/she should assist. In a case where the reason why assistance is requested, the call reason, whether inbound or outbound, and the like are displayed in the assistance requesting notification 2000, the supervisor can know with what he/she should assist in greater detail.

In the example illustrated in FIG. 4, the assistance requesting notification is displayed as a pop-up on the operator monitor window. However, this is an example, and when the supervisor has been viewing another window, the notification is displayed as a pop-up on that window. That is, the assistance requesting notification is displayed as a pop-up on the frontmost window. Hence, even when the supervisor has been doing any other job than monitoring calls of the operators, it is possible to get the supervisor to be aware of the assistance request.

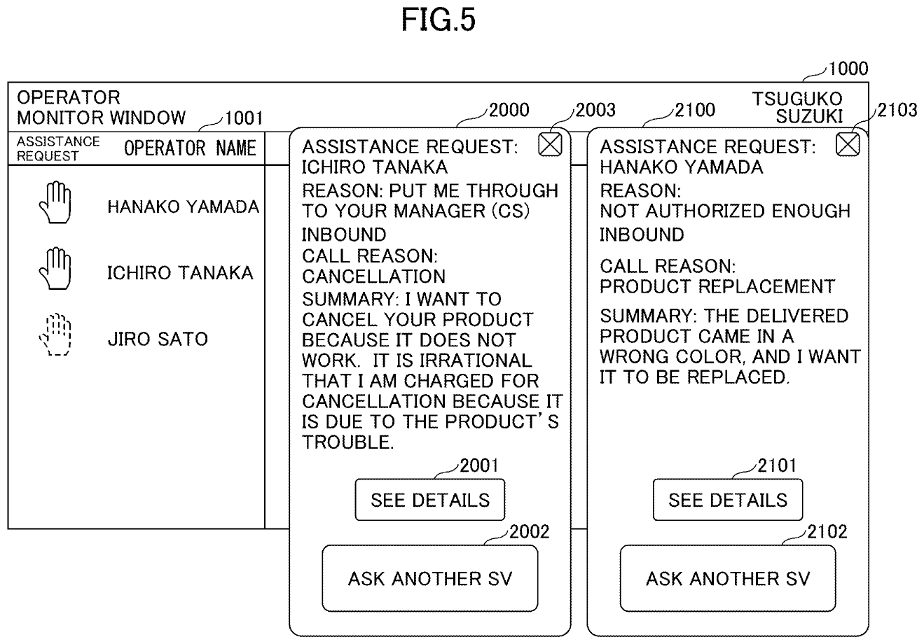

When a supervisor terminal 30 receives a plurality of assistance requesting notifications, the plurality of assistance requesting notifications are displayed as pop-ups. This situation is illustrated in FIG. 5. In the example illustrated in FIG. 5, two assistance requesting notifications including the assistance requesting notification 2000 and an assistance requesting notification 2100 are displayed as pop-ups. The assistance requesting notification 2100 likewise includes a “see details” button 2101, an “ask another SV” button 2102, and a “delete” button 2103. In a case of displaying a plurality of assistance requesting notifications as pop-ups, for example, the notification sound and the sound volume of the notification sound may be changed depending on the number of assistance requesting notifications. Particularly, as the number of assistance requesting notifications is greater, the notification sound may be one that makes the assistance requesting notifications more noticeable, and the sound volume of the notification sound may be higher.

Log information accompanying an assistance request may be stored in, for example, the call data memory unit 104 as call data. Log information may include, e.g., the operator ID and the operator name of the operator who requested assistance, the assistance requesting date and time, the supervisor name of the supervisor who received the assistance request, and the like. Hence, for example, it is possible to use the log information accompanying an assistance request for, for example, analyses for improving the quality of handling.

### In a Case of Selecting “See Details” on Assistance Requesting Notification

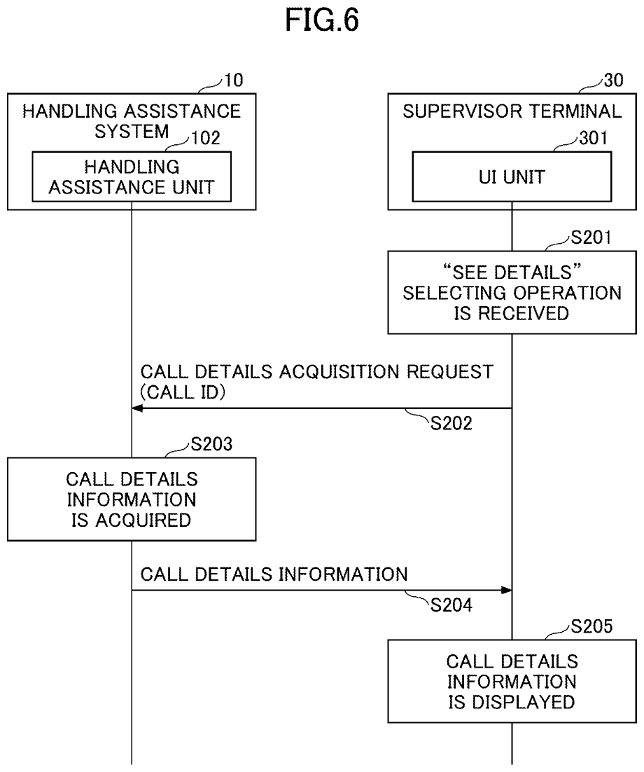

Next, an example of an operation in a case where a supervisor selects “see details” on an assistance requesting notification while the assistance requesting notification is displayed on the supervisor terminal 30 will be described with reference to FIG. 6.

The UI unit 301 of the supervisor terminal 30 receives an operation of the supervisor to select the “see details” button (e.g., an operation to select the “see details” button 2001 included in the assistance requesting notification 2000 in the example illustrated in FIG. 4) (step S201).

Upon receiving the operation of the supervisor to select the “see details” button, the UI unit 301 of the supervisor terminal 30 sends a call details acquisition request to the handling assistance system 10 (step S202). Here, the call details acquisition request includes the call ID of the call under the assistance request.

In response to receiving the call details acquisition request from the supervisor terminal 30, the handling assistance unit 102 of the handling assistance system 10 acquires call details information from the call data corresponding to the call ID included in the call details acquisition request (step S203). That is, the handling assistance unit 102 acquires various information included in the call ID corresponding to the call ID (e.g., the call text and the like) as the call details information.

The handling assistance unit 102 of the handling assistance system 10 sends the call details information acquired in the step S203 described above to the supervisor terminal 30 (step S204).

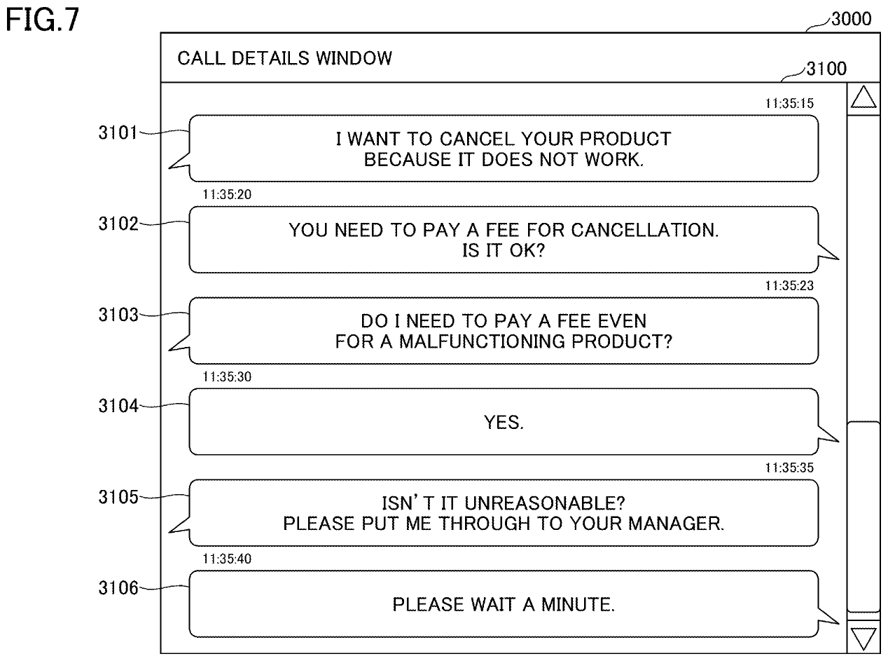

In response to receiving the call details information from the handling assistance system 10, the UI unit 301 of the supervisor terminal 30 displays a call details window based on the call details information (step S205). Here, an example of the call details window is illustrated in FIG. 7. A call details window 3000 illustrated in FIG. 7 includes a call text display field 3100 in which the call text of the call under the assistance request is displayed in real time. In the example illustrated in FIG. 7, call texts 3101 to 3106 are displayed in the call text display field 3100 in time series. Hence, the supervisor can confirm the present and past call texts of the call about which he/she is requested to assist in time series, and can decide what assistance to offer to the operator.

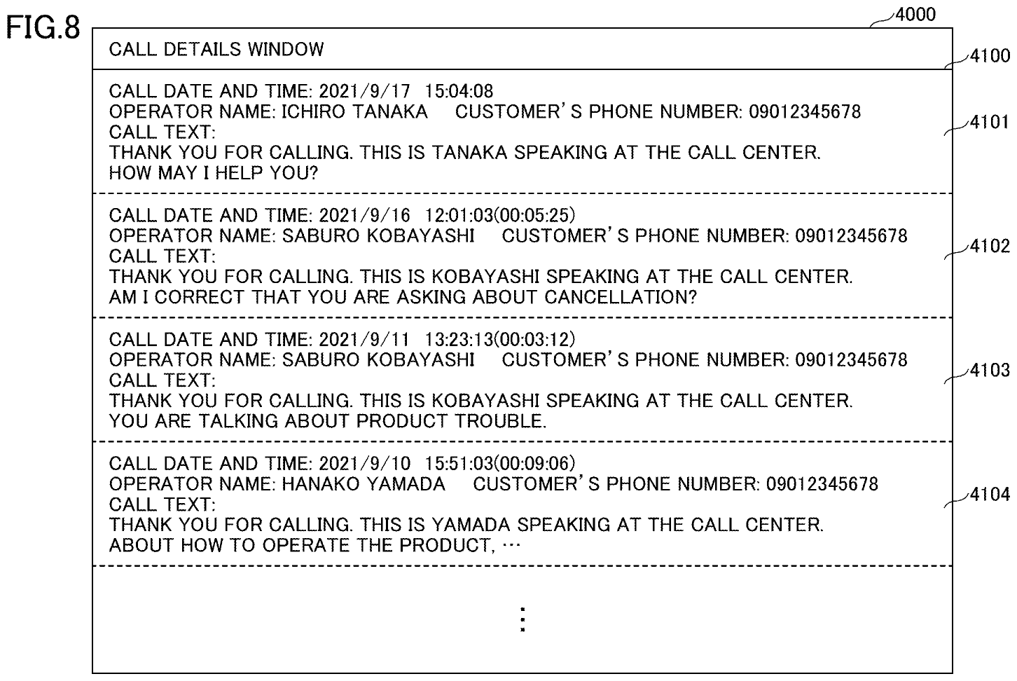

Here, in deciding what assistance to offer to the operator, the supervisor might want to confirm not only the call under the assistance request, but also the past calls of the customer who is on the call. Hence, the call details information of the past calls of the same customer as that who is on that call may also be acquired in addition to the call details information of the call under the assistance request in the step S203 described above, and these plurality of pieces of call details information may be sent to the supervisor terminal 30 in the step S204 described above. In this case, in the step S205 described above, for example, a call details window 4000 illustrated in FIG. 8 is displayed based on these plurality of pieces of call details information. The call details window 4000 illustrated in FIG. 8 includes a call details list 4100 in which the call details information of the call under the assistance request, and the call details information of the past calls of the same customer as that who is on that call are displayed in a list form. In the example illustrated in FIG. 8, call details information 4101 of the call under the assistance request, and call details information 4102 to 4104 of the past calls of the same customer as that who is on that call are displayed in the call details list 4100 in the list form. In the example illustrated in FIG. 8, the call details information of the call under the assistance request includes at least the call date and time, the operator name, the customer's phone number, and the call text, and the call details information of the calls of the same customer as that who is on that call include the time taken for the calls in addition to these items.

Hence, the supervisor can also confirm the past calls of the same customer as that who is on the call under the assistance request. The supervisor can assist the operator by, for example, understanding the customer's complaint in the past calls, the customer's complaint continuous from the past calls, and the like. In a case where the supervisor selects desired call details information from the call details list 4100 on the call details window 4000 illustrated in FIG. 8, a similar call details window to that of FIG. 7 may be displayed regarding the selected call details information.

### In a Case of Selecting “Ask Another SV” on Assistance Requesting Notification

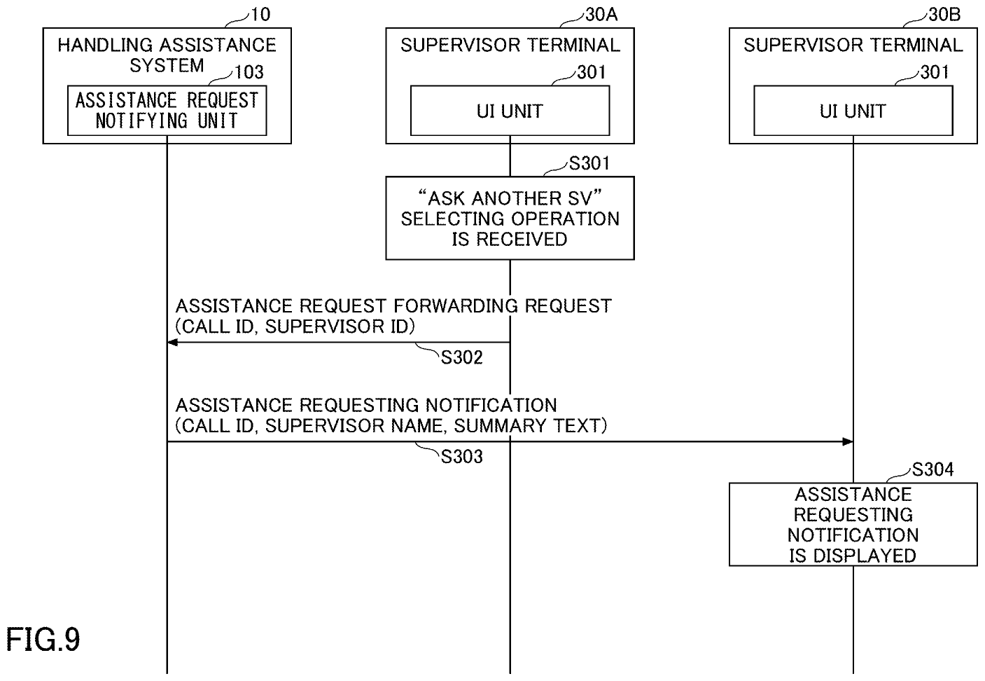

An example of an operation in a case where a supervisor selects “ask another SV” on an assistance requesting notification while the assistance requesting notification is displayed on the supervisor terminal 30 will be described with reference to FIG. 9. Here, for example, the supervisor may not be able to respond to the operator's assistance request for such a reason as being engaged in another job, or the like. In this case, by selecting “ask another SV”, the supervisor can entrust (forward) the assistance request to another supervisor. In the following description, for example, the supervisor terminal 30 on which the assistance requesting notification is displayed is referred to as “supervisor terminal 30A”, and the supervisor terminal 30 to which the assistance requesting notification is forwarded is referred to as “supervisor terminal 30B”. The supervisor using the supervisor terminal 30A is referred to as “supervisor A”, and the supervisor using the supervisor terminal 30B is referred to as “supervisor B”.

The UI unit 301 of the supervisor terminal 30A receives an operation of the supervisor A to select the “ask another SV” button (e.g., an operation to select the “ask another SV” button 2002 included in the assistance requesting notification 2000 in the example illustrated in FIG. 4) (step S301). Here, the supervisor A may perform an operation to select the “ask another SV” button without designating a specific supervisor as the forwardee of the assistance request, or may perform an operation to select the “ask another SV” button by designating the specific supervisor B as the forwardee of the assistance request. In a case where no specific supervisor is designated, it is assumed that a previously fixed supervisor is designated as the forwardee of the assistance request.

Upon receiving the operation of the supervisor A to select the “ask another SV” button, the UI unit 301 of the supervisor terminal 30A sends an assistance request forwarding request to the handling assistance system 10 (step S302). Here, the assistance request forwarding request includes the call ID of the call under the assistance request, the supervisor ID of the supervisor A who is the forwarder of the assistance request (hereinafter, may also be referred to as “forwarder supervisor ID”), and the supervisor ID of the supervisor B designated as the forwardee of the assistance request (hereinafter, may also be referred to as “forwardee supervisor ID”). The supervisor ID is information uniquely identifying a supervisor.

In response to receiving the assistance request forwarding request from the supervisor terminal 30A, the assistance request notifying unit 103 of the handling assistance system 10 sends an assistance requesting notification to the supervisor terminal 30B corresponding to the forwardee supervisor ID included in the assistance request forwarding request, after identifying the supervisor name corresponding to the forwarder supervisor ID included in the assistance request forwarding request (step S303). Here, the assistance requesting notification includes the supervisor name corresponding to the forwarder supervisor ID, and various information (the call ID, the summary text, and the like) included in the forwarding target assistance requesting notification. The various information included in the forwarding target assistance requesting notification may include, for example, the operator name, the call reason, whether inbound or outbound, the reason why assistance is requested, and the like, in addition to the call ID and the summary text.

In response to receiving the assistance requesting notification from the handling assistance system 10, the UI unit 301 of the supervisor terminal 30B displays an assistance requesting notification including information necessary for understanding the reason why assistance is requested, in a manner in which the supervisor can be easily aware of the assistance request (step S304). Specifically, for example, the UI unit 301 displays the assistance requesting notification as a pop-up on the operator monitor window together with a predetermined sound (notification sound), as in the step S107 of FIG. 3.

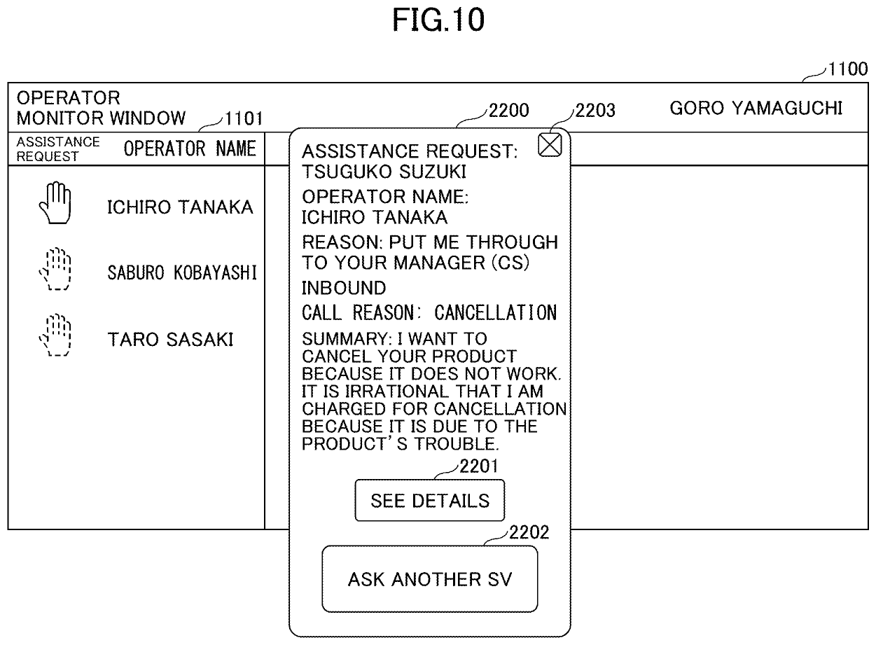

Here, an example of the operator monitor window and the assistance requesting notification displayed as a pop-up on the operator monitor window when an assistance request is forwarded from another supervisor is illustrated in FIG. 10. In the example illustrated in FIG. 10, an assistance requesting notification 2200 forwarded from the supervisor terminal 30A is displayed as a pop-up on an operator monitor window 1100 displayed on the supervisor terminal 30B.

The operator monitor window 1100 illustrated in FIG. 10 is an operator monitor window displayed on the supervisor terminal 30B of “Goro Yamada”, who is the supervisor B, and includes a monitor target operator display field 1101 in which the names of the monitor target operators, and palm icons representing whether the operators are requesting assistance or not are displayed. In the example illustrated in FIG. 10, three operators including “Ichiro Tanaka”, “Saburo Kobayashi”, and “Taro Sasaki” are the monitor targets, and the palm icon of the operator “Ichiro Tanaka”, who is requesting assistance, is displayed by a solid line. On the other hand, the palm icons of the operators “Saburo Kobayashi” and “Taro Sasaki”, who are not requesting assistance, are displayed by a broken line.

The supervisor name, the operator name, the reason why assistance is requested, whether inbound or outbound, the call reason, and the summary text that are included in the assistance requesting notification are displayed in the assistance requesting notification 2200 illustrated in FIG. 10. In the example illustrated in FIG. 10, the supervisor name “Tsuguko Suzuki”, the operator name “Ichiro Tanaka”, the reason why assistance is requested “Put me through to your manager (CS)”, “inbound”, the call reason “cancel”, and the summary text “I want to cancel your product because it does not work. It is irrational that I am charged for cancellation because it is due to the product's trouble.” are displayed. The supervisor name is the name of the supervisor who forwarded the assistance request, and the operator name is the name of the operator who actually requested assistance.

Here, the assistance requesting notification 2200 illustrated in FIG. 10 includes a “see details” button 2201 for confirming the detailed call content on the call under the assistance request, an “ask another SV” button 2202 for entrusting (forwarding) the assistance request to another supervisor, and a “delete” button 2203 for hiding the assistance requesting notification 2200, as in the assistance requesting notification 2000 illustrated in FIG. 4 and the like. An operation in a case where the “see details” button 2201 or the “ask another SV” button 2202 is selected by the supervisor is as described above.

### MODIFIED EXAMPLE

In the embodiment described above, the palm icon displayed on the monitor target operator display field of the operator monitor window merely represents whether assistance is requested or not. This is non-limiting. For example, the palm icon may represent the status of the assistance request.

For example, in a case where the palm icon is displayed by a solid line, the palm icon may represent a status “Assistance request pending” in red, a status “Assistance request declined” in purple, a status “Responded to by another SV” in green, a status “Consultation requested after hanging up” in blue, and the like. Here, for example, in a case of “Responded to by another SV”, the name and the like of the supervisor who responded to the assistance request may be displayed under the palm icon, or the name and the like of the supervisor who responded to the assistance request may be displayed in response to a mouse cursor or the like being overlaid on the palm icon.

### Conclusion

As described above, the handling assistance system 10 according to the present embodiment causes a notification of an assistance request from an operator to be displayed as a pop-up on the corresponding supervisor terminal 30 together with the predetermined notification sound (in other words, sends a push notification together with the predetermined notification sound). Hence, for example, even when the supervisor is doing any other job, the supervisor can be easily aware of the assistance request, and can quickly start responding to the assistance request. The assistance request from the operator includes, for example, “information based on which the supervisor can know with what he/she should assist” such as the summary text of the call content and the like. Hence, the supervisor can easily understand the content of the call under the assistance request, and can return a suitable response.

Moreover, even when an operator who received an assistance requesting notification cannot respond to the assistance request, he/she can forward the assistance request to another operator. Hence, it is possible to avoid a situation in which, for example, the operator cannot put the assistance request through due to busyness and the like of the supervisor. This can consequently contribute to improvement of the customer satisfaction, and the like.

The present invention is not limited to the specifically disclosed foregoing embodiment, and various modifications, changes, combinations with existing techniques, and the like are applicable without departing from the description in the claims.

### REFERENCE SIGNS LIST

1 contact center system
10 handling assistance system
20 operator terminal
50 PBX
60 NW switch
70 customer terminal
80 communication network
101 collecting unit
102 handling assistance unit
103 assistance request notifying unit
104 call data memory unit

1. A handling assistance system, comprising a processor configured to execute operations comprising:
generating a speed recognition text based on speech recognition on voice data in a call handling of customer, wherein the handling assistance system communicably connects to a first terminal and a second terminal, the first terminal is used by a first user who is in charge of the call handling, and the second terminal is used by a second user who assists the first user with the call handling;
generating, based on the speech recognition text, a summary text in response to receiving an assistance request for the call handling from the first terminal, wherein the summary text represents a summary of the speech recognition text; and
transmitting the summary text to the second terminal to cause the second terminal to display an assistance requesting notification and output a predetermined notification sound, wherein the assistance requesting notification comprises the summary text.

2. The handling assistance system according to claim 1, wherein the processor is configured to further execute:
identifying at least one selected from a reason for the assistance request, a call reason in the call handling, and whether the call handling is inbound or outbound based on the speech recognition text,
wherein the transmitting further comprises causing the second terminal to display the assistance requesting notification and output the notification sound, wherein the assistance requesting notification further comprises at least one selected from the reason, the call reason, and the whether the call handling is inbound or outbound identified.

3. The handling assistance system according to claim 1,
wherein the transmitting further comprises transmitting the speech recognition text to the second terminal to cause the second terminal to further display the speech recognition text in response to receiving from the second terminal, a request for displaying details information for the assistance requesting notification.

4. The handling assistance system according to claim 1,
wherein the transmitting further comprises transmitting past call handing information to the second terminal to cause the second terminal to further display the past call handling information regarding a same customer as the customer in the call handling in a list form, in response to receiving from the second terminal, a request for displaying details information for the assistance requesting notification.

5. The handling assistance system according to claim 1,
wherein the transmitting further comprises causing the second terminal to display the assistance requesting notification on a frontmost window of windows displayed on the second terminal and to output the notification sound.

6. The handling assistance system according to claim 1,
wherein the transmitting further comprises forwarding the assistance requesting notification to another second terminal different from the second terminal in response to receiving from the second terminal, a request for forwarding the assistance requesting notification.

7. The handling assistance system according to claim 6,
wherein the transmitting further comprises causing the another second terminal to display the assistance requesting notification, which is a target of forwarding, and output the notification sound.

8. A computer implemented method for assisting a call handling by a handling assistance system, comprising:
generating a speech recognition text based on speech recognition on voice data in a call handling of a customer, wherein the handling assistance system communicably connects to a first terminal and a second terminal, the first terminal is used by a first user who is in charge of the call handling, and the second terminal is used by a second user who assists the first user with the call handling;
generating, based on the speech recognition text, a summary text, in response to receiving an assistance request for the call handling from the first terminal, wherein the summary text represents a summary of the speech recognition text; and
transmitting the summary text to the second terminal to cause the second terminal to display an assistance requesting notification and output a predetermined notification sound, wherein the assistance requesting notification comprises the summary text.

9. A non-transitory computer-readable recording medium storing a program that, when executed by a computer, causes the computer to function as the handling assistance system of claim 1.
